(19) United States
(12) Patent Application Publication
(10) Pub. No.: US 2026/0036083 A1
(43) Pub. Date: Feb. 5, 2026

(54) TURBINE ENGINE HAVING A PARTICLE DEFLECTOR ASSEMBLY

(71) Applicants: General Electric Company, Schenectady, NY (US); General Electric Company Polska sp. z o.o, Warsaw (PL); General Electric Deutschland Holding GmbH, Frankfurt (DE)

(72) Inventors: Pascal Schuler, Munich (DE); Aleksander Pasieczny, Warsaw (PL); Byron A. Pritchard, Loveland, OH (US); Charles D. Califf, Greendale, IN (US)

(21) Appl. No.: 18/680,121

(22) Filed: May 31, 2024

(30) Foreign Application Priority Data
Nov. 22, 2023 (PL) P.446807

(51) Int. Cl. F02C 7/052; B01D 45/08

(52) U.S. Cl. CPC F02C 7/052; B01D 45/08; F05D 2220/323; F05D 2260/607

(57) ABSTRACT

A turbine engine includes an engine plenum disposed within the turbine engine and defined at least partially by a plenum end wall and a turbo-engine disposed within the engine plenum. The turbine engine causes core air to flow through the engine plenum and into the turbo-engine. A particle deflector assembly is disposed at the plenum end wall. The particle deflector assembly includes one or more particle deflector walls that extend into the engine plenum and capture particles within the core air.

### CROSS REFERENCE TO RELATED APPLICATIONS

The present application claims the benefit of Polish Patent Application No. P.446807, filed on Nov. 22, 2023, which is hereby incorporated by reference herein in its entirety.

### TECHNICAL FIELD

The present disclosure relates generally to turbine engines, and, particularly, to turboprop engines.

### BACKGROUND

Turbine engines, particularly, turboprop engines, generally include a propeller and a core section arranged in flow communication with one another. The core section includes a compressor, a combustor, and a turbine section. Reverse flow turboprop engines include an engine plenum in which the core section is disposed.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1A is a schematic partial cutaway view of a turbine engine, according to the present disclosure.

FIG. 1B is a schematic partial cutaway view of an aircraft including the turbine engine of FIG. 1A, according to the present disclosure.

FIG. 1C is a schematic cross-sectional diagram of a portion of an engine plenum of the turbine engine including a particle deflector assembly, taken along a longitudinal centerline axis of the turbine engine and at detail 1C in FIG. 1B, according to the present disclosure.

FIG. 2A is a schematic cross-sectional diagram of a particle deflector assembly for the turbine engine of FIG. 1A, taken along a longitudinal centerline axis of the particle deflector assembly, according to another embodiment.

FIG. 2B shows a portion of the particle deflector assembly of FIG. 2A isolated from the turbine engine, according to the present disclosure.

FIG. 3 is a schematic cross-sectional diagram of a particle deflector assembly for the turbine engine of FIG. 1A, taken along a longitudinal centerline axis of the particle deflector assembly, according to another embodiment.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle with respect to a direction of travel. For example, with regard to a turbine engine, forward refers to a position on the turbine engine that is closer to the propeller or the fan and aft refers to a position on the turbine engine that is further away from the propeller or the fan.

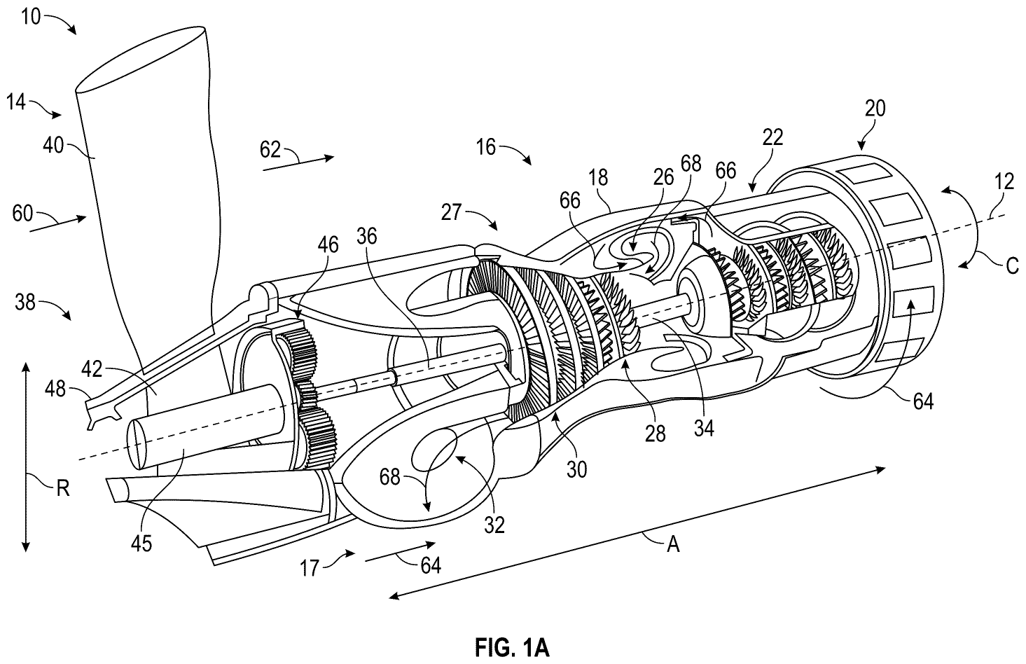

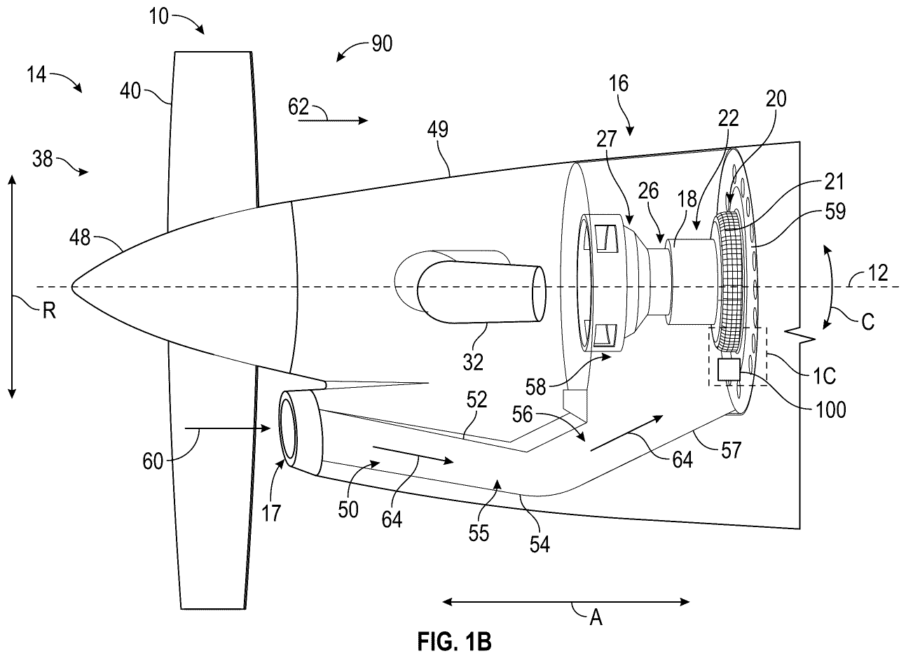

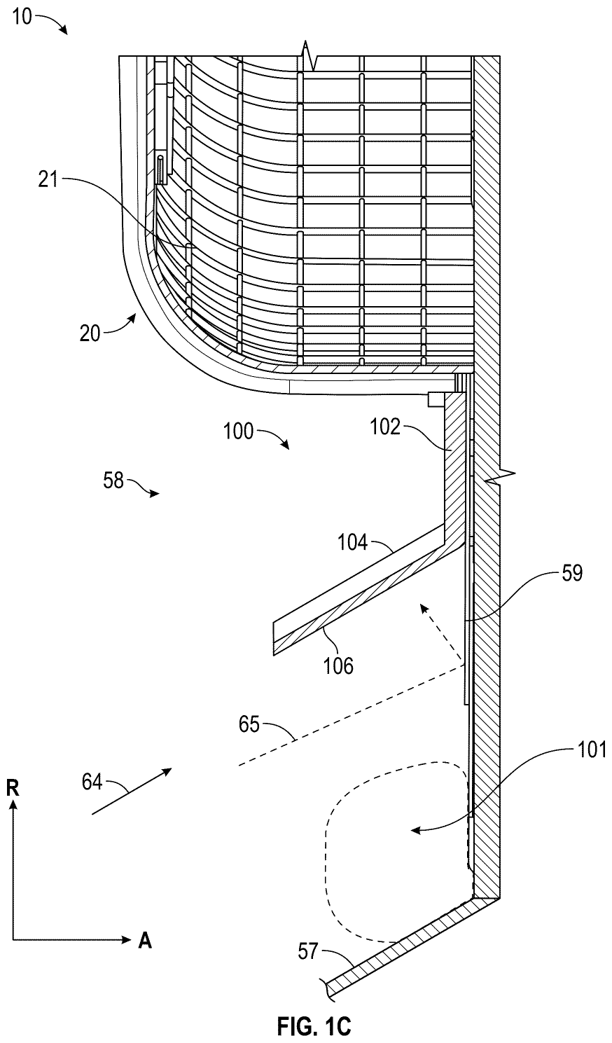

As used herein, “below” refers to a component being radially below another component in the orientation of the turbine engine 10 shown in FIGS. 1A and 1B.

As used herein, “top” refers to a radially outward surface or a radially outward end of a component that is radially higher than a “bottom” in the orientation of the turbine engine 10 shown in the Figures.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, “top” refers to a highest or uppermost point, portion, or surface of a component in the orientations shown in the figures.

As used herein, “bottom” refers to a lowest or lowermost point, portion, or surface of a component in the orientations shown in the figures.

As noted above, reverse flow turboprop engines include a core section that is disposed within an engine plenum. The engine plenum is a spaced within the turbine engine in which the turbo-engine is disposed, as detailed further below. In this way, the engine plenum is a structural element of the turbine engine that is defined within a casing of the turbine engine. An air intake of the reverse flow turboprop engine guides air from the propeller into the engine plenum. The core section can include an inlet screen that prevents large debris in the air from entering core section, thereby preventing foreign object damage (FOD) to the core section. The inlet screen, however, may be unable to prevent smaller debris, such as ice particles, from entering the core section. Ice particles (e.g., ice crystals that are less than 200 micrometers) can form at high altitudes and can be ingested into the engine during a flight. While ice particles are described here, the present disclosure can be utilized to prevent any type of solid particle (e.g., ice, dust, sand, or the like) that is sized such that the inlet screen is unable to prevent such solid particles from entering the core section.

The particles may be ingested through the air intake with the air flow. Such particles can rebound off cold surfaces within the air intake and within the engine plenum, and can flow far into the engine inlet and enter the core section of the engine. When the particles are ice particles, the ice particles can accumulate and form into larger ice chunks. Thus, the particles can damage the components of the core section. The damaged components may cause the compressor to surge or to stall, thereby reducing air flow through the core section. The damaged components can also cause flameout in the combustor, thereby causing thrust loss of the engine. The damaged components can also damage the blades in the compressor or the turbine section as the particles impact the blades. In some instances, the particles, especially ice particles, can cause engine power loss during a flight. Such issues are particularly difficult to avoid when the turbine engine is a turboprop engine due to the geometry of the air intake and the engine plenum of turboprop engines as compared to other types of turbine engines, such as, for example, turbofan engines that include annular inlets.

Current particle ingestion prevention devices utilize heated surfaces in the air intake to melt the ice particles or to utilize centrifugal forces to separate the particles from the air flow. Such devices, however, add complexity and weight to the turbine engine. Further, the heated surfaces may unintentionally transfer heat to other components of the turbine engine or to the aircraft, thereby overheating the other components and reducing a lifecycle of the other components. Such heating devices may be unable to completely melt larger ice particles. Devices that utilize centrifugal forces require additional moving parts to generate the centrifugal forces, thereby adding additional parts that need to be maintained and that can become damaged or fail. Further, such devices placed in the air intake or the engine plenum may cause excessive aerodynamic losses of the airflow that enters the core section, thereby reducing an overall efficiency of the turbine engine.

Accordingly, the present disclosure provides for a particle deflector assembly that includes one or more particle deflector walls positioned within the engine plenum for deflecting the particles and preventing the particles from flowing into the core section. The particle deflector assembly is positioned below (e.g., radially outward and lower than) the engine inlet of the core section in an area where the airflow velocity is low and the particle inertia is high to allow for separation of the particles from the airflow. In particular, the particle deflector assembly is positioned at a plenum end wall of the engine plenum where the plenum end wall redirects the airflow from the air intake towards the core section. In some embodiments, the particle deflector assembly includes a metal sheet that is coupled to the plenum end wall below the core section and extends into the engine plenum. The particles impinge against the metal sheet such that the metal sheet prevents the particles from flowing to the core section through the engine inlet and from re-circulating inside the engine plenum. In this way, the particles are stopped and collected at the bottom of the engine plenum. The particle capture efficiency can be improved by using multiple metal sheets and by segmenting the particle deflector assembly. In some embodiments, the particle deflector assembly includes one or more heated surfaces to initiate melting and evaporating the particles to prevent the particles from re-circulating inside the engine plenum.

Thus, the present disclosure provides for an improved and a simplified particle deflector assembly that prevents the particles from entering the core section of the turbine engine without overly sacrificing aerodynamic performance of the air intake or the engine plenum, as compared to turbine engines without the benefit of the present disclosure.

Referring now to the drawings, FIG. 1A is a schematic partial cutaway view of a turbine engine 10, according to an embodiment of the present disclosure. The turbine engine 10 is a turboprop engine and has a longitudinal centerline axis 12. As shown in FIG. 1A, the turbine engine 10 defines an axial direction A (extending parallel to the longitudinal centerline axis 12 provided for reference), a radial direction R that is normal to the axial direction A, and a circumferential direction C disposed about the axial direction A. In general, the turbine engine 10 includes a propeller section 14 and a turbo-engine 16 disposed downstream from the propeller section 14. The propeller section 14 is driven by the turbo-engine 16, as detailed further below.

The turbine engine 10 includes an air intake 17 aft of the propeller section 14 and forward of the turbo-engine 16. The air intake 17 is a scoop inlet positioned radially outward from the longitudinal centerline axis 12. In the embodiment of FIGS. 1A and 1B, the air intake 17 is positioned at a radially bottom portion of the turbine engine 10 (e.g., below the longitudinal centerline axis 12 in the orientation shown in FIG. 1A). For example, the air intake 17 is positioned below the propeller section 14. The air intake 17 can be positioned at any radial position of the turbine engine 10 (e.g., on a side of the turbine engine 10 or on a radially top portion of the turbine engine 10). The air intake 17 directs air from the propeller section 14 into the turbo-engine 16, as detailed further below. The turbo-engine 16 depicted generally includes an outer casing 18 that is substantially tubular and defines a radial inlet 20 at an axially aft end of the turbo-engine 16. The outer casing 18 encases, in serial flow relationship, a compressor 22, a combustor 26, a turbine section 27 including a high-pressure (HP) turbine 28 followed downstream by a low-pressure (LP) turbine 30, and an exhaust section 32. A high-pressure (HP) shaft 34 or a spool drivingly connects the HP turbine 28 to the compressor 22 to rotate the HP turbine 28 and the compressor 22 in unison. A low-pressure (LP) shaft 36 drivingly connects the LP turbine 30 to the propeller section 14 to rotate the LP turbine 30 and the propeller section 14 in unison. The compressor 22, the combustor 26, the turbine section 27, and the exhaust section 32 together define a core air flow path of the turbine engine 10.

The propeller section 14 includes a propeller 38 having a plurality of propeller blades 40 (only one shown in FIG. 1A) coupled to a disk 42 in a spaced apart manner. The propeller blades 40 extend outwardly from the disk 42 generally along the radial direction R. The propeller blades 40 and the disk 42 are together rotatable about the longitudinal centerline axis 12 via a propeller shaft 45 that is powered by the LP shaft 36 across a power gearbox, also referred to as a gearbox assembly 46. In this way, the propeller 38 is drivingly coupled to the turbo-engine 16 (e.g., to the LP turbine 30). The gearbox assembly 46 includes a plurality of gears for adjusting the rotational speed of the propeller shaft 45 and, thus, the propeller 38 relative to the LP shaft 36. In some embodiments, the propeller 38 is a variable pitch propeller such that each propeller blade 40 is rotatable relative to the disk 42 about a pitch axis by virtue of the propeller blades 40 being operatively coupled to an actuator configured to collectively vary the pitch of the propeller blades 40 in unison. The disk 42 is covered by a rotatable propeller hub 48 aerodynamically contoured to promote an airflow through the plurality of propeller blades 40.

FIG. 1B is a schematic partial cutaway view of an aircraft 90 including the turbine engine 10, according to the present disclosure. As shown in FIG. 1B, a cowling 49 circumferentially surrounds the turbine engine 10 and provides an aerodynamic surface such that air flows over the cowling 49. The turbo-engine 16 is disposed within the cowling 49. The turbine engine 10 includes an intake duct 50 within the cowling 49 that is fluidly coupled with the air intake 17. The intake duct 50 is a flowpath that directs air that passes through the propeller blades 40 into the air intake 17 and to the radial inlet 20 of the turbine engine 10, as detailed further below. The intake duct 50 is defined between an inner duct wall 52 and an outer duct wall 54. The inner duct wall 52 is radially inner of the outer duct wall 54 from the longitudinal centerline axis 12. The intake duct 50 includes a generally axial duct portion 55 and a radially angled duct portion 56. The radially angled duct portion 56 is downstream of the generally axial duct portion 55. At the generally axial duct portion 55, the inner duct wall 52 and the outer duct wall 54 extend generally axially aftward from the air intake 17. At the radially angled duct portion 56, the outer duct wall 54 includes a radially angled duct wall 57 that is angled radially towards the longitudinal centerline axis 12. In this way, the radially angled duct portion 56 is angled towards the longitudinal centerline axis 12 such that the radially angled duct portion 56 directs the air flowing through the intake duct 50 towards the radial inlet 20, as detailed further below. In FIG. 1B, the radially angled duct portion 56 (e.g., the radially angled duct wall 57) is angled at approximately 30° with respect to the longitudinal centerline axis 12. The radially angled duct portion 56 can include any angle from 0° to 90° with respect to the longitudinal centerline axis 12.

The turbine engine 10 includes an engine plenum 58 in fluid communication with the intake duct 50 and within the cowling 49. For example, the engine plenum 58 is fluidly coupled with the radially angled duct portion 56 of the intake duct 50. The engine plenum 58 is a structural element that is defined as a space within the turbine engine 10 for housing the turbo-engine 16. The turbo-engine 16 is disposed within the engine plenum 58. The engine plenum 58 is defined at least partially by a plenum end wall 59 that defines a back wall of the turbine engine 10 and separates the turbine engine 10 from the rest of the aircraft 90. The air flows from the radially angled duct portion 56 into the engine plenum 58 and is directed into the radial inlet 20, as detailed further below. The engine plenum 58 has an axial plenum length that extends in the axial direction A, a radial plenum height that extends in the radial direction R, and a circumferential plenum width that extends in the circumferential direction C. The radially angled duct wall 57 defines a bottom surface of the engine plenum 58 and defines the circumferential plenum width of the engine plenum 58.

With reference to FIGS. 1A and 1B, during operation of the turbine engine 10, a volume of air 60 passes through the propeller blades 40 of the propeller 38. As the volume of air 60 passes across the plurality of propeller blades 40, a first portion of air, referred to as bypass air 62, is directed or routed over the cowling 49 (FIG. 1B), and a second portion of air, referred to as core air 64 is directed or is routed into the intake duct 50 through the air intake 17. The intake duct 50 directs the core air 64 axially aftward towards the turbo-engine 16. In particular, the generally axial duct portion 55 directs the core air 64 from the air intake 17 axially aftward. The radially angled duct portion 56 directs the core air 64 from the generally axial duct portion 55 to the engine plenum 58. For example, a portion of the core air 64 impinges on the radially angled duct wall 57 such that the core air 64 is redirected and is angled radially from the generally axial duct portion 55 towards the engine plenum 58. The core air 64 impinges on the plenum end wall 59 and is directed into the radial inlet 20 such that the core air 64 enters the turbo-engine 16. For example, the core air 64 flows generally radially into the radial inlet 20. In some examples, a mean path of the core air 64 enters the engine plenum 58 in a range of 30° to 90° with respect to a mean path of the air entering the radial inlet 20. The radial inlet 20 includes an inlet screen 21 (e.g., a foreign object debris (FOD) screen) disposed about the radial inlet 20 that prevents undesirable debris from entering the turbo-engine 16. The turbine engine 10 also includes a particle deflector assembly 100 (shown schematically in FIG. 1B) for preventing smaller particles, such as ice particles or other solid particles (e.g., dust, sand, etc.), from entering the turbo-engine 16, as detailed further below.

The turbo-engine 16 is a reverse flow engine such that the core air 64 flows through the turbo-engine 16 from an aft end of the turbo-engine 16 to a forward end of the turbo-engine 16. In this way, the turbine engine 10 is referred to as a reverse flow turboprop engine. The radial inlet 20 directs the core air 64 downstream to the compressor 22. In the compressor 22, a pressure of the core air 64 is increased, forming compressed air 66 (FIG. 1A), and the compressed air 66 is routed into the combustor 26, where the compressed air 66 is mixed with fuel and burned to generate combustion gases 68 (FIG. 1A). In the embodiment of FIGS. 1A and 1B, the combustor 26 is a reverse flow combustor such that the compressed air 66 flows from the compressor 22, around the combustor 26, and enters the combustor 26 at a forward end of the combustor 26. In this way, the compressed air 66 flows aftward within the combustor 26 and the combustion gases 68 are then directed from the combustor 26 forward to the turbine section 27.

In the turbine section 27, the combustion gases 68 are routed into the HP turbine 28 (FIG. 1A) and expanded through the HP turbine 28 where a portion of thermal energy and kinetic energy from the combustion gases 68 is extracted via sequential stages of HP turbine stator vanes that are coupled to the outer casing 18 and HP turbine rotor blades that are coupled to the HP shaft 34 (FIG. 1A), thus, causing the HP shaft 34 to rotate, thereby supporting operation of the compressor 22. The combustion gases 68 are then routed into the LP turbine 30 (FIG. 1A) and expanded through the LP turbine 30. Here, a second portion of the thermal energy and kinetic energy is extracted from the combustion gases 68 via sequential stages of LP turbine stator vanes that are coupled to the outer casing 18 and LP turbine rotor blades that are coupled to the LP shaft 36 (FIG. 1A), thus, causing the LP shaft 36 to rotate, thereby causing the propeller 38 to rotate via the gearbox assembly 46 (FIG. 1A). The combustion gases 68 are subsequently routed through the exhaust section 32 and out of the turbo-engine 16 to provide propulsive thrust.

During operation, particles (e.g., ice particles, dust, sand, etc.) in the core air 64 may enter the radial inlet 20, thereby entering the turbo-engine 16. In such instances, the particles may damage components (e.g., the compressor 22, the combustor 26, or the turbine section 27) of the turbo-engine 16 or can reduce an aerodynamic efficiency of the components of the turbo-engine 16. Accordingly, the present disclosure provides the particle deflector assembly 100 that prevents the particles in the core air 64 from entering the radial inlet 20, and, thus, from entering the turbo-engine 16, as detailed further below.

The turbine engine 10 depicted in FIGS. 1A and 1B is by way of example only. In other exemplary embodiments, the turbine engine 10 may have any other suitable configuration. For example, in other exemplary embodiments, the propeller 38 may be configured in any other suitable manner (e.g., as a fixed pitch propeller) and further may be supported using any other suitable propeller frame configuration. Moreover, in other exemplary embodiments, any other suitable number or configuration of compressors, turbines, shafts, or a combination thereof may be provided. In certain exemplary embodiments, the turbine engine 10 of FIGS. 1A to 1C may be utilized to drive a propeller of a helicopter, may be utilized in aeroderivative applications, or may be attached to a propeller for an airplane. Additionally, in other exemplary embodiments, the turbine engine 10 may include any other suitable type of combustor, and may not include the exemplary reverse flow combustor depicted.

FIG. 1C is a schematic cross-sectional diagram of a portion of the engine plenum 58 of the turbine engine 10 including the particle deflector assembly 100, taken along the longitudinal centerline axis 12 and at detail 1C in FIG. 1B, according to the present disclosure. As shown in FIG. 1C, a mean (e.g., average) path of the core air 64 (as depicted by an arrow streamline in FIG. 1C) is generally parallel with the radially angled duct wall 57 prior to the plenum end wall 59 redirecting the core air 64 towards the radial inlet 20. The mean path of the core air 64 may be angled with respect to the radially angled duct wall 57 by plus or minus twenty degrees (±20°) due to the core air 64 being directed towards the radial inlet 20 within the engine plenum 58. The particle deflector assembly 100 causes a portion of the core air 64 to separate from the radially angled duct wall 57 and generates a low momentum flow of the core air 64, also referred to as a recirculation zone 101. The portion of the core air 64 that forms the recirculation zone 101 generates a swirl, or a vortex, of the core air 64 to define the recirculation zone 101. In this way, the recirculation zone 101 includes the portion of the core air 64 that swirls, or recirculates, within the recirculation zone 101. The velocity of the portion of the core air 64 in the recirculation zone 101 is lower than the velocity of the core air 64 that is directed into the radial inlet 20 (e.g., the core air 64 that is outside of the recirculation zone 101).

The particle deflector assembly 100 deflects particles in the core air 64 and the recirculation zone 101 decelerates the particles and prevents the particles from flowing towards and into the radial inlet 20, as detailed further below. In this way, the particle deflector assembly 100 separates the particles from the core air 64 and captures the particles to prevent the particles from entering the turbo-engine 16 (e.g., through the radial inlet 20). In the embodiment of FIG. 1C, the particle deflector assembly 100 deflects the particles such that the particles spread circumferentially along the particle deflector assembly 100. The particle deflector assembly 100 also captures the particles within the recirculation zone 101.

The particle deflector assembly 100 is positioned radially between the radial inlet 20 and the radially angled duct wall 57. In particular, the particle deflector assembly 100 is positioned in an area of the engine plenum 58 in which an inertia of the particles is high such that the particles do not follow the mean path of the core air 64. For example, the particle deflector assembly 100 is positioned in an area of the engine plenum 58 in which a mean path of the particles (as indicated by the dashed arrow 65) diverges from the mean path of the core air 64 by at least ten degrees (10°). In particular, the particle deflector assembly 100 is positioned radially inward (e.g., closer to the longitudinal centerline axis 12 of FIG. 1B) and axially aft of the area at which the mean path of the particles diverges from the mean path of the core air 64. In this way, the particle deflector assembly 100 captures the particles that separate from the core air 64 and flow towards the plenum end wall 59. In some embodiments, the particle deflector assembly 100 is positioned in an area of the engine plenum 58 in which the mean path of the particles diverges from the mean path of the core air 64 in a range of ten degrees to forty-five degrees (10° to 45°).

The particle deflector assembly 100 is disposed at the plenum end wall 59 in an area of the engine plenum 58 where kinetic energy of the particles is greater than kinetic energy of the core air 64 such that the particles continue their path towards the plenum end wall 59, while the engine plenum 58 redirects the core air 64 towards the radial inlet 20. In this way, the particle deflector assembly 100 is positioned in an area in which the particles have difficulty following the flow of the core air 64 that turns towards the radial inlet 20 as the core air 64 impinges on the plenum end wall 59. Such a location of the particle deflector assembly 100 provides for separating a majority (e.g., greater than 50%) of the particles from the core air 64 without overly sacrificing aerodynamic performance of the intake duct 50 (e.g., without overly decreasing air pressure of the core air 64 within the intake duct 50 or without introducing additional pressure losses within the intake duct 50).

The particle deflector assembly 100 includes one or more deflector end walls 102 and one or more particle deflector walls 104 that are angled from the one or more deflector end walls 102. The one or more deflector end walls 102 extend generally radially along the radial direction R and are coupled to the plenum end wall 59 such that the one or more deflector end walls 102 form a part of the plenum end wall 59. The one or more deflector end walls 102 can be coupled to the plenum end wall 59 by any coupled means, such as, for example, bolts, welding, or the like. In some embodiments, the one or more deflector end walls 102 are formed with the plenum end wall 59 such that the one or more deflector end walls 102 and the plenum end wall 59 form a single, unitary component.

The one or more particle deflector walls 104 extend from the one or more deflector end walls 102. The one or more particle deflector walls 104 are angled at a core air deflector angle with respect to the mean path of the core air 64 in the engine plenum 58. The core air deflector angle is measured from the mean path of the core air 64 to the one or more particle deflector walls 104 (e.g., to one or more particle deflector surfaces 106 of the one or more particle deflector walls 104). For example, the core air deflector angle is greater than 0° and less than or equal to 60° such that the particles in the core air 64 impinge on the one or more particle deflector walls 104, and the one or more particle deflector walls 104 prevent the particles from entering the radial inlet 20. The one or more particle deflector walls 104 extend axially forward from a bottom end of the one or more deflector end walls 102 and extend into the engine plenum 58. In some embodiments, the deflector angle of the one or more particle deflector walls 104 is substantially equal to an angle of the radially angled duct wall 57 with respect to the plenum end wall 59.

In some embodiments, the one or more particle deflector walls 104 are angled at a particle deflector angle with respect to the mean path of the particles (as indicated by the dashed arrow 65) in the engine plenum 58. The particle deflector angle is measured from the mean path of the particles to the one or more particle deflector walls 104 (e.g., to the one or more particle deflector surfaces 106 of the one or more particle deflector walls 104). For example, the particle deflector angle is in a range of 30° to 90° such that the particles in the core air 64 impinge on the one or more particle deflector walls 104, and the one or more particle deflector walls 104 prevent the particles from entering the radial inlet 20.

The particle deflector assembly 100 includes the one or more particle deflector surfaces 106 that deflect the particles and prevents the particles from flowing towards the radial inlet 20. The one or more particle deflector surfaces 106 are defined by a bottom surface of the one or more particle deflector walls 104. In this way, the one or more particle deflector surfaces 106 extend axially forward of the plenum end wall 59 and extend into the engine plenum 58 such that the particles impinge on the one or more particle deflector surfaces 106, as detailed further below.

The particle deflector assembly 100 has an axial deflector length that extends in the axial direction A, a radial deflector height that extends in the radial direction R, and a circumferential deflector width that extends in the circumferential direction C (FIG. 1B). The axial deflector length is defined as a length, measured along the axial direction A, from the plenum end wall 59 to an axial forward end of the particle deflector assembly 100 (e.g., of the one or more particle deflector walls 104). The radial deflector height is defined as a height, measured along the radial direction R, from a bottom surface (e.g., the one or more particle deflector surfaces 106) at the axial forward end of the particle deflector assembly 100 (e.g., of the one or more particle deflector walls 104) to a top surface at a radially top end of the particle deflector assembly 100 (e.g., at the top surface of the one or more deflector end walls 102). The circumferential deflector width is defined as a width, measured along the circumferential direction C (FIG. 1B), from a circumferential forward surface of the particle deflector assembly 100 to a circumferential aft surface of the particle deflector assembly 100.

In the embodiment of FIGS. 1B and 1C, the circumferential deflector width of the particle deflector assembly 100 is substantially equal to the circumferential plenum width of the engine plenum 58. In this way, the particle deflector assembly 100 extends substantially an entirety of the circumferential plenum width. In some embodiments, the circumferential deflector width is less than the circumferential plenum width such that the particle deflector assembly 100 extends only partially along the circumferential plenum width of the engine plenum 58. The axial deflector length is equal to or less than 70% of an axial length of the radial inlet 20. The radial deflector height is equal to or less than 60% of a radial height of the plenum end wall 59 from the radially angled duct wall 57 at the plenum end wall 59 to a radially inner surface of the radial inlet 20. Accordingly, the particle deflector assembly 100 has a size (e.g., a surface area defined by the axial deflector length and the circumferential deflector width) that prevents a majority (e.g., at least 50%) of the particles in the core air 64 from entering the turbo-engine 16 (FIG. 1B) through the radial inlet 20. The values of the axial deflector length and the radial deflector height are exemplary only, and the values can be different based on a particular engine plenum configuration.

The particle deflector assembly 100 is formed of one or more sheets, such as from metal, or the like. The particle deflector assembly 100 can be made from any material that blocks particles in the core air 64 from entering the radial inlet 20. In some embodiments, the particle deflector assembly 100 can be segmented such that the particle deflector assembly 100 is made of a plurality of segments. In some embodiments, the particle deflector assembly 100 includes a bleed flow opening defined by the one or more particle deflector walls 104 that direct a portion of the core air 64 through the bleed flow opening and out of the particle deflector assembly 100 such that the portion of the core air 64 flows towards the turbo-engine 16 (e.g., towards the radial inlet 20). In some embodiments, the particle deflector assembly 100 (e.g., the one or more particle deflector walls 104) is heated such that the particle deflector assembly 100 melts the particles that contact the particle deflector assembly 100. For example, the particle deflector assembly 100 can be heated by coils disposed within the particle deflector assembly 100 (e.g., within the one or more particle deflector walls 104). In some embodiments, hot compressor bleed air from the compressor 22 (FIG. 1A) is directed towards the particle deflector assembly 100 to heat the particle deflector assembly 100. Heating the particle deflector assembly 100 helps with capturing the particles within the particle deflector assembly 100 (e.g., within the recirculation zone 101).

In operation, the core air 64 flows through the engine plenum 58, impinges on the plenum end wall 59, and is directed into the radial inlet 20, as detailed above. The particles in the core air 64 separate from the core air 64 (e.g., the mean path of the particles diverges from the mean path of the core air 64) and impinge against the plenum end wall 59 and flow in a direction of the radial inlet 20 (as indicated by the dashed arrow 65). The particle deflector assembly 100 prevents the particles from continuing to flow towards the radial inlet 20 and from entering the radial inlet 20. In particular, the particles impinge on the one or more particle deflector walls 104 (e.g., the one or more particle deflector surfaces 106) of the particle deflector assembly 100. In this way, the particle deflector assembly 100 captures the particles and prevents the particles from continuing to flow towards the radial inlet 20 and from entering the radial inlet 20, and, thus, from entering the turbo-engine 16 (FIGS. 1A and 1B).

The particle deflector assembly 100 decelerates the particles when the particles impinge on the one or more particle deflector walls 104 such that the particles fall towards the recirculation zone 101 and away from the radial inlet 20. A portion of the particles may decelerate upon impinging on the plenum end wall 59 such that the portion of the particles fall towards the recirculation zone 101 without contacting the particle deflector assembly 100. The recirculation zone 101 circulates the particles such that the recirculation zone 101 prevents the particles from flowing back into the flow of the core air 64. In this way, the particle deflector assembly 100 separates the particles from the core air 64 and captures the particles to prevent the particles from entering the radial inlet 20. The particle deflector assembly 100 helps to capture the particles at a bottom of the engine plenum 58 (e.g., on the radially angled duct wall 57).

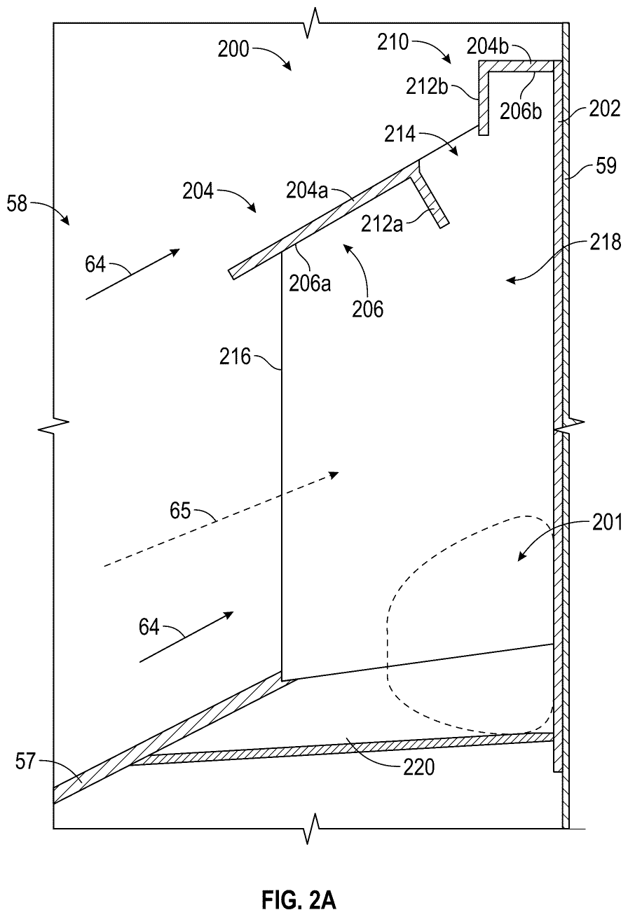

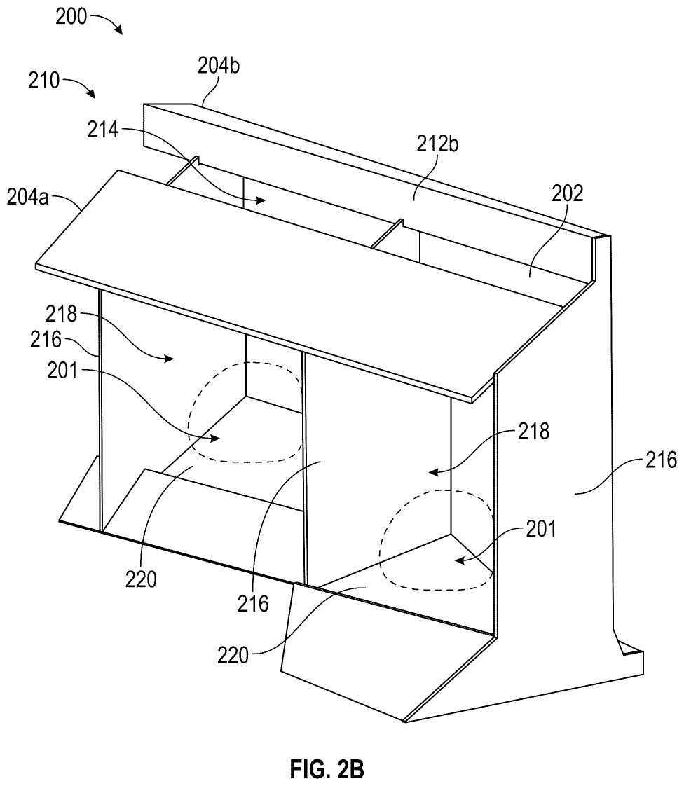

FIG. 2A is a schematic cross-sectional diagram of a particle deflector assembly 200 for the turbine engine 10, taken along a longitudinal centerline axis of the particle deflector assembly 200, according to another embodiment. FIG. 2B shows a portion of the particle deflector assembly 200 isolated from the turbine engine 10, according to the present disclosure. The particle deflector assembly 200 causes a portion of the core air 64 to separate from the radially angled duct wall 57 and generates a low momentum flow of the core air 64, also referred to as a recirculation zone 201. The particle deflector assembly 200 is substantially similar to the particle deflector assembly 100 of FIGS. 1B and 1C and is positioned within the engine plenum 58, similarly as does the particle deflector assembly 100. The particle deflector assembly 200 includes one or more deflector end walls 202 and one or more particle deflector walls 204. The particle deflector assembly 200 includes an axial deflector length, a radial deflector height, and a circumferential deflector width. The axial deflector length is defined as a length, measured along the axial direction A, from the plenum end wall 59 to an axial forward end of the particle deflector assembly 200 (e.g., of the one or more particle deflector walls 204). The radial deflector height is defined as a height, measured along the radial direction R, from a bottom surface (e.g., a bottom deflector wall 220) at the axial forward end of the particle deflector assembly 200 to a top surface at a radially top end of the particle deflector assembly 200 (e.g., at the top surface of the one or more deflector end walls 202). The circumferential deflector width is defined as a width, measured along the circumferential direction C (FIG. 1B), from a circumferential forward surface of the particle deflector assembly 200 to a circumferential aft surface of the particle deflector assembly 200.

The one or more deflector end walls 202 are coupled to, or are formed with, the plenum end wall 59, such that the one or more deflector end walls 202 form a part of the plenum end wall 59. In this way, the particle deflector assembly 200 is disposed at the plenum end wall 59. The one or more particle deflector walls 204 are positioned at a top end of the particle deflector assembly 200. The one or more particle deflector walls 204 include a first particle deflector wall 204a and a second particle deflector wall 204b. The first particle deflector wall 204a is spaced axially forward from the one or more deflector end walls 202. The first particle deflector wall 204a is angled with respect to the mean path of the core air 64 at a core air deflector angle that is greater than 0° and less than or equal to 60°. In some embodiments, the first particle deflector wall 204a is angled with respect to the mean path of the particles (as indicated by the dashed arrow 65) at a particle deflector angle that is greater than 10°, and, is preferably in a range of 30° to 90°. The second particle deflector wall 204b is positioned at a top end of the one or more deflector end walls 202 and extends generally axially forward from the one or more deflector end walls 202.

The particle deflector assembly 200 includes one or more particle deflector surfaces 206 on which the particles impinge such that the particle deflector assembly 200 captures the particles and prevents the particles from flowing towards the radial inlet 20. The one or more particle deflector surfaces 206 are defined by a bottom surface of the one or more particle deflector walls 204 such that the particles impinge the bottom surface of the one or more particle deflector walls 204. The one or more particle deflector surfaces 206 include a first particle deflector surface 206a and a second particle deflector surface 206b. The first particle deflector surface 206a is defined by a bottom surface of the first particle deflector wall 204a. The second particle deflector surface 206b is defined by a bottom surface of the second particle deflector wall 204b.

The particle deflector assembly 200 also includes a louver assembly 210 and a plurality of vertical segment walls 216. The louver assembly 210 includes a first louver wall 212a and a second louver wall 212b. The first louver wall 212a is defined by the first particle deflector wall 204a at an axially aft end of the first particle deflector wall 204a and extends generally towards the one or more deflector end walls 202 (e.g., towards the plenum end wall 59). The second louver wall 212b is defined by the second particle deflector wall 204b at an axially forward end of the second particle deflector wall 204b and extends generally radially towards the radially angled duct wall 57.

The first particle deflector wall 204a is spaced axially forward from the second particle deflector wall 204b such that the first louver wall 212a is spaced axially forward from the second louver wall 212b. In this way, the particle deflector assembly 200 includes a bleed flow opening 214 defined between the first particle deflector wall (e.g., the first louver wall 212a) and the second particle deflector wall 204b (e.g., the second louver wall 212b). As shown in FIG. 2B, the bleed flow opening 214 includes a single bleed flow opening 214 that extends an entirety of the circumferential deflector width of the particle deflector assembly 200. In some embodiments, the particle deflector assembly 200 includes a plurality of bleed flow openings 214 that is spaced along the circumferential deflector width of the particle deflector assembly 200.

The particle deflector assembly 200 also includes a bottom deflector wall 220 that contacts the radially angled duct wall 57 such that the bottom deflector wall 220 forms a part of the radially angled duct wall 57. In some embodiments, the bottom deflector wall 220 is coupled to the radially angled duct wall 57 or forms a single, unitary component with the radially angled duct wall 57. The plurality of vertical segment walls 216 extends from the bottom deflector wall 220 to the top end of the particle deflector assembly 200. The one or more deflector end walls 202 and the one or more particle deflector walls 204 are coupled to the plurality of vertical segment walls 216. The plurality of vertical segment walls 216 is spaced circumferentially along the circumferential deflector width such that the particle deflector assembly 200 is segmented to define one or more deflector chambers 218. Each of the one or more deflector chambers 218 is defined between two of the plurality of vertical segment walls 216. The one or more deflector chambers 218 retain the particles that are captured by the particle deflector assembly 200.

The particle deflector assembly 200 operates substantially similarly as does the particle deflector assembly 100 of FIGS. 1B and 1C. In particular, the core air 64 flows through the engine plenum 58, impinges on the plenum end wall 59, and is directed into the radial inlet 20, as detailed above. Particles in the core air 64 impinge against the plenum end wall 59 and flow into the one or more deflector chambers 218 (as indicated by the dashed arrow 65). In this way, the particle deflector assembly 200 captures the particles and prevents the particles from entering the radial inlet 20. In particular, the particles impinge on the plenum end wall 59 (e.g., the one or more deflector end walls 202) within the one or more deflector chambers 218. A portion of the particles impinge on the one or more particle deflector walls 204 (e.g., the one or more particle deflector surfaces 206). For example, the portion of the particles can impinge on at least one of the first particle deflector wall 204a (e.g., the first particle deflector surface 206a) of the second particle deflector wall 204b (e.g., the second particle deflector surface 206b). In this way, the particle deflector assembly 200 prevents the particles from continuing to flow towards the radial inlet 20 and from entering the turbo-engine 16 (FIGS. 1A and 1B) through the radial inlet 20.

The particle deflector assembly 200 decelerates the particles when the particles impinge on the plenum end wall 59 (e.g., the one or more deflector end walls 202) and on the one or more particle deflector walls 204 such that the particles fall towards the recirculation zone 201 and away from the radial inlet 20. The recirculation zone 201 circulates the particles such that the recirculation zone 201 prevents the particles from flowing back into the flow of the core air 64. In this way, the particle deflector assembly 200 separates the particles from the core air 64 and captures the particles to prevent the particles from entering the radial inlet 20. The particle deflector assembly 200 helps to collect the particles at a bottom of the engine plenum 58 (e.g., on the radially angled duct wall 57) (FIG. 1B). The one or more deflector chambers 218 facilitate collection of a greater number of particles than does the particle deflector assembly 100 of FIGS. 1B and 1C without the plurality of vertical segment walls.

The bleed flow opening 214 directs a portion of the core air 64 from the one or more deflector chambers 218 such that the portion of the core air 64 flows from the particle deflector assembly 200 to the radial inlet 20 (FIG. 1B). The bleed flow opening 214 is sized to control an amount of the portion of the core air 64 that flows through the bleed flow opening 214 and to control a size of the recirculation zone 201. The size of the bleed flow opening 214 is selected to allow the core air 64 to flow therethrough, while also preventing the particles from escaping the particle deflector assembly 200.

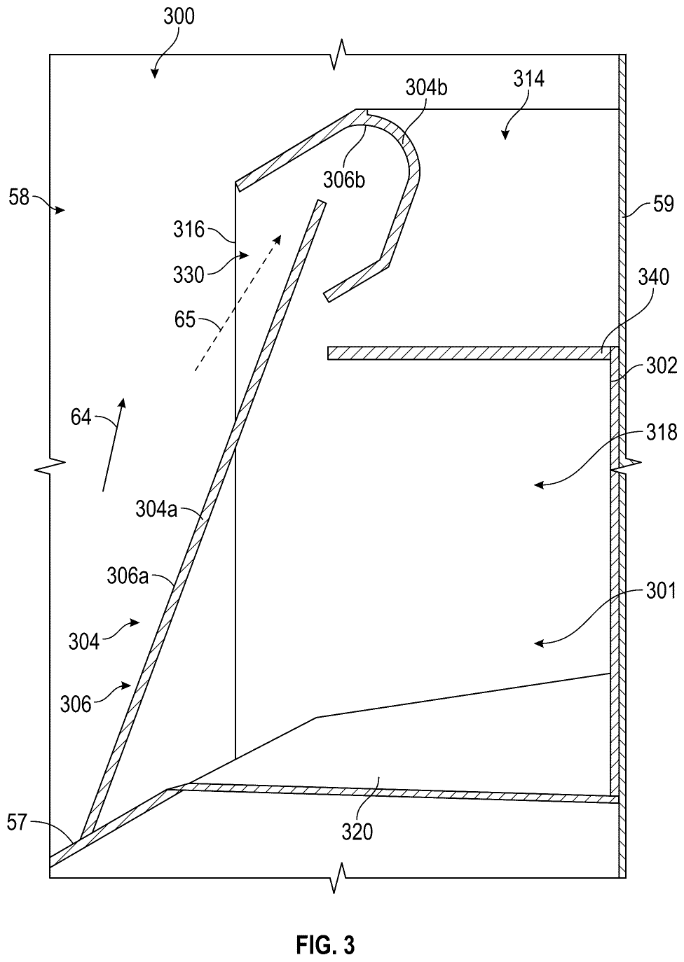

FIG. 3 is a schematic cross-sectional diagram of a particle deflector assembly 300 for the turbine engine 10, taken along a longitudinal centerline axis of the particle deflector assembly 300, according to another embodiment. The particle deflector assembly 300 causes a portion of the core air 64 to separate from the radially angled duct wall 57 and generates a low momentum flow of the core air 64, also referred to as a recirculation zone 301. The recirculation zone 301 is defined by one or more deflector chambers 318, as detailed further below. The particle deflector assembly 300 is substantially similar to the particle deflector assemblies 100, 200 of FIGS. 1B to 1C and 2A to 2B, respectively, and is positioned within the engine plenum 58 similarly as the particle deflector assemblies 100, 200. The particle deflector assembly 300 includes an axial deflector length, a radial deflector height, and a circumferential deflector width. The particle deflector assembly 300 includes one or more deflector end walls 302, one or more particle deflector walls 304, a plurality of vertical segment walls 316, the one or more deflector chambers 318, and a bottom deflector wall 320.

The one or more deflector end walls 302 are coupled to, or are formed with, the plenum end wall 59 such that the one or more deflector end walls 302 form a part of the plenum end wall 59. In this way, the particle deflector assembly 300 is disposed at the plenum end wall 59. The one or more particle deflector walls 304 include a first particle deflector wall 304a and a second particle deflector wall 304b. The first particle deflector wall 304a is positioned at a forward end of the particle deflector assembly 300 and extends in the radial direction R and is angled axially aftward towards the one or more deflector end walls 302. The first particle deflector wall 304a is angled with respect to the mean path of the core air 64 at a core air deflector angle that is greater than 0° and less than or equal to 60°. In some embodiments, the first particle deflector wall 304a is angled with respect to the mean path of the particles (as indicated by the dashed arrow 65) at a particle deflector angle that is in a range of 30° to 90°.

The second particle deflector wall 304b is positioned at a top end (e.g., a radially outward end closer to the radial inlet 20) of the particle deflector assembly 300 and is spaced axially forward from the plenum end wall 59. In this way, the particle deflector assembly 300 includes a bleed flow opening 314 defined between the plenum end wall 59 and the second particle deflector wall 304b. The second particle deflector wall 304b is a curved wall that deflects the particles into the one or more deflector chambers 318. For example, the second particle deflector wall 304b is a generally U-shaped wall that prevents the particles from flowing towards the radial inlet 20 and directs the particles into the particle deflector assembly 300 (e.g., into the one or more deflector chambers 318). The second particle deflector wall 304b is spaced radially from the first particle deflector wall 304a such that a chamber opening 330 is defined between the first particle deflector wall 304a and the second particle deflector wall 304b.

The particle deflector assembly 300 includes a plurality of particle deflector surfaces 306, including a first particle deflector surface 306a and a second particle deflector surface 306b. The first particle deflector surface 306a is defined by a top surface of the first particle deflector wall 304a and the second particle deflector surface 306b is defined by a bottom surface of the second particle deflector wall 304b. In this way, the particles impinge on the first particle deflector surface 306a of the first particle deflector wall 304a and on the second particle deflector surface 306b of the second particle deflector wall 304b such that the particle deflector assembly 300 directs the particles into the one or more deflector chambers 318 to capture the particles, as detailed further below.

The plurality of vertical segment walls 316 extends from the bottom deflector wall 320 to the top end of the particle deflector assembly 300. The one or more deflector end walls 302 and the one or more particle deflector walls 304 are coupled to the plurality of vertical segment walls 316. The plurality of vertical segment walls 316 is spaced circumferentially along the circumferential deflector width such that the particle deflector assembly 300 is segmented into a plurality of particle deflector segments. In this way, the particle deflector assembly 300 includes one or more deflector chambers 318. Each of the one or more deflector chambers 318 is defined between two of the plurality of vertical segment walls 316. The one or more deflector chambers 318 retain the particles that the particle deflector assembly 300 collects.

The particle deflector assembly 300 includes one or more deflector chamber walls 340 that are disposed within the one or more deflector chambers 318. The one or more deflector chamber walls are spaced radially below the second particle deflector wall 304b and extend generally axially forward, for example, from the one or more deflector end walls 302. The one or more deflector end walls 302 extend radially from the bottom deflector wall 320 to the one or more deflector chamber walls 340. In this way, the one or more deflector end walls 302 extend only a portion of the radial height of the particle deflector assembly 300, and the one or more deflector chamber walls 340 are positioned at a top end of the one or more deflector end walls 302. In some embodiments, the one or more deflector end walls 302 extend an entirety, or substantially an entirety, of the radial deflector height of the particle deflector assembly 300, and the one or more deflector chamber walls 340 are positioned radially between the bottom deflector wall 320 and the second particle deflector wall 304b. Each of the one or more deflector chambers 318 defines the recirculation zone 301 such that the recirculation zone 301 is defined between the bottom deflector wall 320, the one or more deflector chamber walls 340, the one or more deflector end walls 302, and the first particle deflector wall 304a.

The particle deflector assembly 300 operates substantially similarly as do the particle deflector assemblies 100, 200 of FIGS. 1B to 1C and 2A to 2B. In particular, the core air 64 flows through the engine plenum 58, impinges on the plenum end wall 59, and is directed into the radial inlet 20, as detailed above. The particle deflector assembly 300 prevents the particles from entering the radial inlet 20. The particles in the core air 64 flow towards the particle deflector assembly 300 (as indicated by the dashed arrow 65) and impinge against the one or more particle deflector walls 304 (e.g., against the one or more particle deflector surfaces 306). In particular, the particles impinge on the first particle deflector wall 304a (e.g., the first particle deflector surface 306a) and the first particle deflector wall 304a directs the particles radially and axially towards the second particle deflector wall 304b (e.g., the second particle deflector surface 306b).

The particles impinge on the second particle deflector wall 304b (e.g., the second particle deflector surface 306b) and the second particle deflector wall 304b directs the particles into the one or more deflector chambers 318. The second particle deflector wall 304b is shaped to direct the particles between the first particle deflector wall 304a and the one or more deflector chamber walls 340 within the one or more deflector chambers 318. In this way, the particle deflector assembly 300 directs the particles below the one or more deflector chamber walls 340 such that the one or more deflector chamber walls 340 prevent the particles from flowing towards the radial inlet 20 from the particle deflector assembly 300. In this way, the particle deflector assembly 300 captures the particles therein.

A portion of the core air 64 also flows into the particle deflector assembly 300 and into the one or more deflector chambers 318. The bleed flow opening 314 directs the portion of the core air 64 from the one or more deflector chambers 318 such that the portion of the core air 64 flows from the particle deflector assembly 300 to the radial inlet 20 (FIG. 1B).

Accordingly, the present disclosure provides for an improved and a simplified particle deflector assembly that prevents the particles from entering the turbo-engine without structural changes to the air intake, the intake duct, or the engine plenum. The particle deflector assemblies of the present disclosure prevent the particles from entering the turbo-engine without overly sacrificing aerodynamic performance of the air intake or the engine plenum as compared to turbine engines without the benefit of the present disclosure. The recirculation zone decelerates the particles such that the particle deflector assembly prevents the particles from flowing into the turbo-engine through the radial inlet.

Further aspects of the present disclosure are provided by the subject matter of the following clauses.

A turbine engine including an engine plenum disposed within the turbine engine and defined at least partially by a plenum end wall, a turbo-engine disposed within the engine plenum, the turbine engine causing core air to flow through the engine plenum and into the turbo-engine, and a particle deflector assembly disposed at the plenum end wall, the particle deflector assembly including one or more particle deflector walls that extend into the engine plenum and capture particles within the core air.

The turbine engine of the preceding clause, the one or more particle deflector walls extending away from the plenum end wall and into the engine plenum.

The turbine engine of any preceding clause, the particle deflector assembly preventing the particles from entering the turbo-engine.

The turbine engine of any preceding clause, the one or more particle deflector walls of the particle deflector assembly defining a recirculation zone such that the one or more particle deflector walls cause a portion of the core air to generate a swirl of the portion of the core air within the recirculation zone, and the recirculation zone decelerates the particles.

The turbine engine of any preceding clause, the one or more particle deflector walls including one or more particle deflector surfaces, at least one of the one or more particle deflector surfaces is defined by a bottom surface of the one or more particle deflector walls, and the particles impinge on the one or more particle deflector surfaces.

The turbine engine of any preceding clause, the particle deflector assembly defining a bleed flow opening defined by the one or more particle deflector walls, the bleed flow opening directing a portion of the core air entering the bleed flow opening to flow out of the particle deflector assembly and towards the turbo-engine.

The turbine engine of any preceding clause, the particle deflector assembly being positioned radially inward and axially aft of an area of the engine plenum in which a mean path of the particles diverges from a mean path of the core air in a range of 10° to 45°.

The turbine engine of any preceding clause, the one or more particle deflector walls including at least one particle deflector wall that is disposed at a particle deflector angle with respect to a mean path of the particles, the particle deflector angle being in a range of 30° to 90°.

The turbine engine of any preceding clause, the turbo-engine defining a radial inlet for receiving the core air into the turbo-engine, and the particle deflector assembly is positioned upstream of the radial inlet.

The turbine engine of any preceding clause, a mean path of the core air entering the engine plenum being at an angle in a range of 30° to 90° with respect to a mean path of the core air entering the radial inlet.

The turbine engine of any preceding clause, further including a propeller drivingly coupled to the turbo-engine, the propeller rotating to direct the core air into the engine plenum.

The turbine engine of any preceding clause, further including a longitudinal centerline axis and an air intake in fluid communication with the engine plenum and positioned radially outward from the longitudinal centerline axis, the air intake directing the core air from the propeller to the engine plenum.

The turbine engine of any preceding clause, further comprising an intake duct defined between the air intake and the engine plenum, the intake duct providing fluid communication between the air intake and the engine plenum and directing the core air from the air intake to the engine plenum.

The turbine engine of any preceding clause, the turbine engine being a turboprop engine.

The turbine engine of any preceding clause, the turbo-engine including a compressor, a combustor, and a turbine section.

The turbine engine of any preceding clause, the compressor being axially aft of the combustor and the combustor being axially aft of the turbine section.

The turbine engine of any preceding clause, the turbo-engine being axially aft of the propeller.

The turbine engine of any preceding clause, the core air flowing into the compressor and the compressor compressing the core air to generate compressed air.

The turbine engine of any preceding clause, the compressed air flowing into the combustor and mixing with fuel to generate a fuel-air mixture, and the combustor combusting the fuel-air mixture to generate combustion gases.

The turbine engine of any preceding clause, the combustion gases flowing from the combustor to the turbine section.

The turbine engine of any preceding clause, the turbine section expanding the combustion gases and directing the combustion gases out of the turbine engine through an exhaust section.

The turbine engine of any preceding clause, the turbine section including a low-pressure turbine and a high-pressure turbine.

The turbine engine of any preceding clause, the compressor being drivingly coupled to the high-pressure turbine such that rotation of the high-pressure turbine causes the compressor to rotate.

The turbine engine of any preceding clause, the propeller being drivingly coupled to the low-pressure turbine such that rotation of the low-pressure turbine causes the propeller to rotate.

The turbine engine of any preceding clause, further including a gearbox assembly, the propeller being drivingly coupled to the low-pressure turbine through the gearbox assembly.

The turbine engine of any preceding clause, further including a low-pressure shaft, the propeller and the low-pressure turbine being drivingly coupled to the low-pressure shaft.

The turbine engine of any preceding clause, further including a high-pressure shaft, the compressor and the high-pressure turbine being drivingly coupled to the high-pressure shaft.

The turbine engine of any preceding clause, the turbine engine being a reverse flow engine such that the core air flows through the turbo-engine from an aft end of the turbo-engine to a forward end of the turbo-engine.

The turbine engine of any preceding clause, further including an intake duct defined between an air intake and the engine plenum, the intake duct directing the core air from the air intake to the engine plenum.

The turbine engine of any preceding clause, the intake duct being defined by an inner duct wall and an outer duct wall.

The turbine engine of any preceding clause, the intake duct including a radially angled duct portion that is angled towards the engine plenum, the radially angled duct portion changing an angle of the core air towards the engine plenum.

The turbine engine of any preceding clause, the angled duct portion including a radially angled duct wall that defines a bottom surface of the engine plenum.

The turbine engine of any preceding clause, the turbine engine having an axial direction, a radial direction, and a circumferential direction.

The turbine engine of any preceding clause, the engine plenum having an axial plenum length that extends in the axial direction, a radial plenum height that extends in the radial direction, and a circumferential plenum width that extends in the circumferential direction.

The turbine engine of any preceding clause, the radial inlet including an inlet screen that prevents foreign object debris from entering the turbo-engine.

The turbine engine of any preceding clause, the particle deflector assembly causing a portion of the core air to separate from the radially angled duct wall to generate the recirculation zone.

The turbine engine of any preceding clause, a velocity of the portion of the core air in the recirculation zone being less than a velocity of the core air that enters the turbo-engine.

The turbine engine of any preceding clause, the particle deflector assembly being positioned between the turbo-engine and the radially angled duct wall.

The turbine engine of any preceding clause, the particle deflector assembly being positioned in an area of the engine plenum in which a mean path of the particles diverges from a mean path of the core air by at least 10°.

The turbine engine of any preceding clause, the particle deflector assembly being positioned upstream of the turbo-engine.

The turbine engine of any preceding clause, the mean path of the core air being angled with respect to the radially angled duct wall by ±20°.

The turbine engine of any preceding clause, the one or more particle deflector walls deflecting the particles such that the particles spread circumferentially along the particle deflector assembly.

The turbine engine of any preceding clause, the particle deflector assembly preventing at least 50% of the particles that enter the air intake from entering the turbo-engine.

The turbine engine of any preceding clause, the particle deflector assembly including one or more deflector end walls that are disposed at the plenum end wall and extend generally radially.

The turbine engine of any preceding clause, the one or more particle deflector walls extending from the one or more deflector end walls.

The turbine engine of any preceding clause, the one or more particle deflector walls directing the particles towards the recirculation zone when the particles impinge on the one or more particle deflector walls.

The turbine engine of any preceding clause, the particle deflector assembly having a circumferential deflector width that extends in the circumferential direction.

The turbine engine of any preceding clause, the circumferential deflector width being substantially equal to the circumferential plenum width of the engine plenum.

The turbine engine of any preceding clause, the particle deflector assembly being formed of one or more sheets of metal.

The turbine engine of any preceding clause, the particle deflector assembly being heated such that the particle deflector assembly melts the particles that contact the particle deflector assembly.

The turbine engine of any preceding clause, the one or more particle deflector walls being positioned at a top end of the particle deflector assembly.

The turbine engine of any preceding clause, the one or more particle deflector walls including a first particle deflector wall and a second particle deflector wall.

The turbine engine of any preceding clause, the first particle deflector wall being spaced axially forward from the second particle deflector wall.

The turbine engine of any preceding clause, the first particle deflector wall being angled at the deflector angle.

The turbine engine of any preceding clause, the second particle deflector wall being positioned at a top end of the one or more deflector end walls and extending generally axially forward from the one or more deflector end walls.

The turbine engine of any preceding clause, the one or more particle deflector surfaces including a first particle deflector surface defined by a bottom surface of the first particle deflector wall.

The turbine engine of any preceding clause, the one or more particle deflector surfaces including a second particle deflector surface defined by a bottom surface of the second particle deflector wall.

The turbine engine of any preceding clause, the first particle deflector wall being spaced axially from the second particle deflector wall to define the bleed flow opening.

The turbine engine of any preceding clause, the particle deflector assembly further including a louver assembly that includes a first louver wall and a second louver wall spaced axially from the first louver wall to define the bleed flow opening.

The turbine engine of any preceding clause, the first louver wall defined by the first particle deflector wall.

The turbine engine of any preceding clause, the second louver wall defined by the second particle deflector wall.

The turbine engine of any preceding clause, the particle deflector assembly including a bottom deflector wall that contacts the radially angled duct wall.

The turbine engine of any preceding clause, further including a plurality of vertical segment walls that extend from the bottom deflector wall to the top end of the particle deflector assembly.

The turbine engine of any preceding clause, the plurality of vertical segment walls being spaced circumferentially along the circumferential deflector width of the particle deflector assembly.

The turbine engine of any preceding clause, the particle deflector assembly defining one or more deflector chambers between the plurality of vertical segment walls.

The turbine engine of any preceding clause, the one or more deflector chambers retaining the particles therein.

The turbine engine of any preceding clause, the first particle deflector wall being positioned at a forward end of the particle deflector assembly and extending in the radial direction.

The turbine engine of any preceding clause, the first particle deflector wall being angled axially aftward towards the one or more deflector end walls.

The turbine engine of any preceding clause, the second particle deflector wall being positioned at a top end of the particle deflector assembly and being spaced axially forward from the plenum end wall.

The turbine engine of any preceding clause, the bleed flow opening being defined between the plenum end wall and the second particle deflector wall.

The turbine engine of any preceding clause, the second particle deflector wall being a curved wall that directs the particles into the one or more deflector chambers.

The turbine engine of any preceding clause, the second particle deflector wall being spaced radially from the first particle deflector wall such that a chamber opening is defined between the first particle deflector wall and the second particle deflector wall.

The turbine engine of any preceding clause, the first particle deflector surface being defined by a top surface of the first particle deflector wall such that the particles impinge on the first particle deflector surface, and the first particle deflector walls directs the particles towards the second particle deflector wall.

The turbine engine of any preceding clause, the second particle deflector surface being defined by a bottom surface of the second particle deflector wall such that the particles from the first particle deflector wall impinge on the second particle deflector surface, and the second particle deflector wall directs the particles into the one or more deflector chambers.

The turbine engine of any preceding clause, the particle deflector assembly including one or more deflector chamber walls disposed within the one or more deflector chambers and extending axially within the one or more deflector chambers.

The turbine engine of any preceding clause, the one or more deflector chamber walls extending generally axially forward from the one or more deflector end walls.

The turbine engine of any preceding clause, the one or more deflector chamber walls being spaced radially from the second particle deflector wall and being spaced axially aftward from the first particle deflector wall within the one or more deflector chambers.

The turbine engine of any preceding clause, the one or more particle deflector walls including at least one particle deflector wall that is disposed at a core air deflector angle with respect to a mean path of the core air in the engine plenum, the core air deflector angle being in a range of 0° to 60°.

The turbine engine of any preceding clause, the particle deflector assembly being positioned at the intersection the mean path of the core air entering the engine plenum and the mean path of the air entering the radial inlet.

The turbine engine of any preceding clause, the radial inlet being disposed at an axially aft end of the turbo-engine.

An engine plenum for a turbine engine comprising a plenum end wall that at least partially defines the engine plenum, a turbo-engine disposed within the engine plenum, the turbine engine causing core air to flow through the engine plenum and into the turbo-engine, and a particle deflector assembly disposed at the plenum end wall, the particle deflector assembly including one or more particle deflector walls that extend into the engine plenum and capture particles within the core air.

The engine plenum of the preceding clause, the one or more particle deflector walls extending away from the plenum end wall and into the engine plenum.

The engine plenum of any preceding clause, the particle deflector assembly preventing the particles from entering the turbo-engine.

The engine plenum of any preceding clause, the one or more particle deflector walls of the particle deflector assembly defining a recirculation zone such that the one or more particle deflector walls cause a portion of the core air to generate a swirl of the portion of the core air within the recirculation zone, and the recirculation zone decelerates the particles.

The engine plenum of any preceding clause, the one or more particle deflector walls including one or more particle deflector surfaces, at least one of the one or more particle deflector surfaces is defined by a bottom surface of the one or more particle deflector walls, and the particles impinge on the one or more particle deflector surfaces.

The engine plenum of any preceding clause, the particle deflector assembly defining a bleed flow opening defined by the one or more particle deflector walls, the bleed flow opening directing a portion of the core air entering the bleed flow opening to flow out of the particle deflector assembly and towards the turbo-engine.

The engine plenum of any preceding clause, the particle deflector assembly being positioned radially inward and axially aft of an area of the engine plenum in which a mean path of the particles diverges from a mean path of the core air in a range of 10° to 45°.

The engine plenum of any preceding clause, the one or more particle deflector walls including at least one particle deflector wall that is disposed at a particle deflector angle with respect to a mean path of the particles, the particle deflector angle being in a range of 30° to 90°.

The engine plenum of any preceding clause, the turbo-engine defining a radial inlet for receiving the core air into the turbo-engine, and the particle deflector assembly is positioned upstream of the radial inlet.

The engine plenum of any preceding clause, a mean path of the core air entering the engine plenum being at an angle in a range of 30° to 90° with respect to a mean path of the core air entering the radial inlet.

The engine plenum of any preceding clause, the turbine engine being a turboprop engine.

The engine plenum of any preceding clause, the turbo-engine including a compressor, a combustor, and a turbine section.

The engine plenum of any preceding clause, the compressor being axially aft of the combustor and the combustor being axially aft of the turbine section.

The engine plenum of any preceding clause, the turbo-engine being axially aft of the propeller.

The engine plenum of any preceding clause, the core air flowing into the compressor and the compressor compressing the core air to generate compressed air.

The engine plenum of any preceding clause, the compressed air flowing into the combustor and mixing with fuel to generate a fuel-air mixture, and the combustor combusting the fuel-air mixture to generate combustion gases.

The engine plenum of any preceding clause, the combustion gases flowing from the combustor to the turbine section.

The engine plenum of any preceding clause, the turbine section expanding the combustion gases and directing the combustion gases out of the turbine engine through an exhaust section.

The engine plenum of any preceding clause, the turbine section including a low-pressure turbine and a high-pressure turbine.

The engine plenum of any preceding clause, the compressor being drivingly coupled to the high-pressure turbine such that rotation of the high-pressure turbine causes the compressor to rotate.

The engine plenum of any preceding clause, the turbine engine being a reverse flow engine such that the core air flows through the turbo-engine from an aft end of the turbo-engine to a forward end of the turbo-engine.

The engine plenum of any preceding clause, the engine plenum having an axial direction, a radial direction, and a circumferential direction.

The engine plenum of any preceding clause, the engine plenum having an axial plenum length that extends in the axial direction, a radial plenum height that extends in the radial direction, and a circumferential plenum width that extends in the circumferential direction.

The engine plenum of any preceding clause, the radial inlet including an inlet screen that prevents foreign object debris from entering the turbo-engine.

The engine plenum of any preceding clause, the particle deflector assembly causing a portion of the core air to separate from the radially angled duct wall to generate the recirculation zone.

The engine plenum of any preceding clause, a velocity of the portion of the core air in the recirculation zone being less than a velocity of the core air that enters the turbo-engine.

The engine plenum of any preceding clause, the particle deflector assembly being positioned between the turbo-engine and the radially angled duct wall.

The engine plenum of any preceding clause, the particle deflector assembly being positioned in an area of the engine plenum in which a mean path of the particles diverges from a mean path of the core air by at least 10°.

The engine plenum of any preceding clause, the particle deflector assembly being positioned upstream of the turbo-engine.

The engine plenum of any preceding clause, the mean path of the core air being angled with respect to the radially angled duct wall by ±20°.

The engine plenum of any preceding clause, the one or more particle deflector walls deflecting the particles such that the particles spread circumferentially along the particle deflector assembly.

The engine plenum of any preceding clause, the particle deflector assembly preventing at least 50% of the particles that enter the air intake from entering the turbo-engine.

The engine plenum of any preceding clause, the particle deflector assembly including one or more deflector end walls that are disposed at the plenum end wall and extend generally radially.

The engine plenum of any preceding clause, the one or more particle deflector walls extending from the one or more deflector end walls.

The engine plenum of any preceding clause, the one or more particle deflector walls directing the particles towards the recirculation zone when the particles impinge on the one or more particle deflector walls.

The engine plenum of any preceding clause, the particle deflector assembly having a circumferential deflector width that extends in the circumferential direction.

The engine plenum of any preceding clause, the circumferential deflector width being substantially equal to the circumferential plenum width of the engine plenum.

The engine plenum of any preceding clause, the particle deflector assembly being formed of one or more sheets of metal.

The engine plenum of any preceding clause, the particle deflector assembly being heated such that the particle deflector assembly melts the particles that contact the particle deflector assembly.

The engine plenum of any preceding clause, the one or more particle deflector walls being positioned at a top end of the particle deflector assembly.

The engine plenum of any preceding clause, the one or more particle deflector walls including a first particle deflector wall and a second particle deflector wall.

The engine plenum of any preceding clause, the first particle deflector wall being spaced axially forward from the second particle deflector wall.

The engine plenum of any preceding clause, the first particle deflector wall being angled at the deflector angle.

The engine plenum of any preceding clause, the second particle deflector wall being positioned at a top end of the one or more deflector end walls and extending generally axially forward from the one or more deflector end walls.

The engine plenum of any preceding clause, the one or more particle deflector surfaces including a first particle deflector surface defined by a bottom surface of the first particle deflector wall.

The engine plenum of any preceding clause, the one or more particle deflector surfaces including a second particle deflector surface defined by a bottom surface of the second particle deflector wall.

The engine plenum of any preceding clause, the first particle deflector wall being spaced axially from the second particle deflector wall to define the bleed flow opening.

The engine plenum of any preceding clause, the particle deflector assembly further including a louver assembly that includes a first louver wall and a second louver wall spaced axially from the first louver wall to define the bleed flow opening.

The engine plenum of any preceding clause, the first louver wall defined by the first particle deflector wall.

The engine plenum of any preceding clause, the second louver wall defined by the second particle deflector wall.

The engine plenum of any preceding clause, the particle deflector assembly including a bottom deflector wall that contacts the radially angled duct wall.

The engine plenum of any preceding clause, further including a plurality of vertical segment walls that extend from the bottom deflector wall to the top end of the particle deflector assembly.

The engine plenum of any preceding clause, the plurality of vertical segment walls being spaced circumferentially along the circumferential deflector width of the particle deflector assembly.

The engine plenum of any preceding clause, the particle deflector assembly defining one or more deflector chambers between the plurality of vertical segment walls.

The engine plenum of any preceding clause, the one or more deflector chambers retaining the particles therein.

The engine plenum of any preceding clause, the first particle deflector wall being positioned at a forward end of the particle deflector assembly and extending in the radial direction.

The engine plenum of any preceding clause, the first particle deflector wall being angled axially aftward towards the one or more deflector end walls.

The engine plenum of any preceding clause, the second particle deflector wall being positioned at a top end of the particle deflector assembly and being spaced axially forward from the plenum end wall.

The engine plenum of any preceding clause, the bleed flow opening being defined between the plenum end wall and the second particle deflector wall.

The engine plenum of any preceding clause, the second particle deflector wall being a curved wall that directs the particles into the one or more deflector chambers.

The engine plenum of any preceding clause, the second particle deflector wall being spaced radially from the first particle deflector wall such that a chamber opening is defined between the first particle deflector wall and the second particle deflector wall.

The engine plenum of any preceding clause, the first particle deflector surface being defined by a top surface of the first particle deflector wall such that the particles impinge on the first particle deflector surface, and the first particle deflector walls directs the particles towards the second particle deflector wall.

The engine plenum of any preceding clause, the second particle deflector surface being defined by a bottom surface of the second particle deflector wall such that the particles from the first particle deflector wall impinge on the second particle deflector surface, and the second particle deflector wall directs the particles into the one or more deflector chambers.

The turbine engine of any preceding clause, the particle deflector assembly including one or more deflector chamber walls disposed within the one or more deflector chambers and extending axially within the one or more deflector chambers.

The engine plenum of any preceding clause, the one or more deflector chamber walls extending generally axially forward from the one or more deflector end walls.

The engine plenum of any preceding clause, the one or more deflector chamber walls being spaced radially from the second particle deflector wall and being spaced axially aftward from the first particle deflector wall within the one or more deflector chambers.

The engine plenum of any preceding clause, the one or more particle deflector walls including at least one particle deflector wall that is disposed at a core air deflector angle with respect to a mean path of the core air in the engine plenum, the core air deflector angle being in a range of 0° to 60°.

The engine plenum of any preceding clause, the particle deflector assembly being positioned at the intersection the mean path of the core air entering the engine plenum and the mean path of the air entering the radial inlet.

The engine plenum of any preceding clause, the radial inlet being disposed at an axially aft end of the turbo-engine.

A method of separating particles in a turbine engine, the method including directing core air into an engine plenum that is disposed within the turbine engine and defined at least partially by a plenum end wall such that the core air impinges on the plenum end wall and is directed into a turbo-engine disposed within the engine plenum, and separating the particles within the core air with one or more particle deflector walls of a particle deflector assembly that is disposed at the plenum end wall and extends into the engine plenum such that the particle deflector assembly captures the particles.

The method of the preceding clause, the turbine engine being the turbine engine of any preceding clause.

The method of any preceding clause, further comprising preventing the particles from entering the turbo-engine with the particle deflector assembly.

The method of any preceding clause, further including generating a swirl of a portion of the core air with the one or more particle deflector walls of the particle deflector assembly to define a recirculation zone, and decelerating the particles in the recirculation zone.

The method of any preceding clause, the one or more particle deflector walls including one or more particle deflector surfaces, at least one of the one or more particle deflector surfaces is defined by a bottom surface of the one or more particle deflector walls, and the method further includes causing the particles to impinge on the one or more particle deflector surfaces.

The method of any preceding clause, the particle deflector assembly further including a bleed flow opening defined by the one or more particle deflector walls, and the method further includes directing, by the bleed flow opening, a portion of the core air out of the particle deflector assembly and towards the turbo-engine.

The method of any preceding clause, further comprising disposing at least one particle deflector wall of the one or more particle deflector walls at a core air deflector angle with respect to the plenum end wall such that the at least one particle deflector wall extends away from the plenum end wall, and the core air deflector angle is in a range of 0° to 60°, and capturing the particles with the at least one particle deflector wall that is disposed at the core air deflector angle.

The method of any preceding clause, further comprising positioning the particle deflector assembly radially inward and axially aft of an area of the engine plenum in which a mean path of the particles diverges from a mean path of the core air in a range of 10° to 45°, and separating the particles from the core air at the area of the engine plenum in which the mean path of the particles diverges from the mean path of the core air such that the particle deflector assembly captures the particles.

The method of any preceding clause, the turbo-engine defining a radial inlet and the particle deflector assembly is positioned upstream of the radial inlet, and the method further includes directing the core air through the radial inlet into the turbo-engine.

The method of any preceding clause, the turbine engine including a propeller drivingly coupled to the turbo-engine, and the method further includes causing the propeller to rotate to generate the core air and directing the core air into the engine plenum.

The method of any preceding clause, the turbine engine including a longitudinal centerline axis and an air intake in fluid communication with the engine plenum and positioned radially outward from the longitudinal centerline axis, and the method further includes directing the core air through the air intake from the propeller to the engine plenum.

The method of any preceding clause, the turbine engine being the turbine engine of any preceding clause.

The method of any preceding clause, further including directing the core air into the compressor and compressing the core air with the compressor to generate compressed air.

The method of any preceding clause, further including directing the compressed air into the combustor and mixing the compressed air with fuel to generate a fuel-air mixture, and combusting the fuel-air mixture with the combustor to generate combustion gases.

The method of any preceding clause, further including directing the combustion gases from the combustor to the turbine section.

The method of any preceding clause, further including expanding the combustion gases in the turbine section and directing the combustion gases out of the turbine engine through an exhaust section.

The method of any preceding clause, the turbine section including a low-pressure turbine and a high-pressure turbine.

The method of any preceding clause, the compressor being drivingly coupled to the high-pressure turbine, and the method including rotating the compressor by rotation of the high-pressure turbine.

The method of any preceding clause, the propeller being drivingly coupled to the low-pressure turbine, and the method including rotating the propeller by rotation of the low-pressure turbine.

The method of any preceding clause, the turbine engine being a reverse flow engine, and the method further including directing the core air through the turbo-engine from an aft end of the turbo-engine to a forward end of the turbo-engine.

The method of any preceding clause, further including an intake duct defined between an air intake and the engine plenum, and the method further including directing the core air from the air intake to the engine plenum through the intake duct.

The method of any preceding clause, the radial inlet including an inlet screen, the method further including preventing foreign object debris from entering the turbo-engine with the inlet screen.

The method of any preceding clause, the radial inlet being disposed at an axially aft end of the turbo-engine.

The method of any preceding clause, further including causing a portion of the core air to separate from the radially angled duct wall to generate the recirculation zone with the particle deflector assembly.

The method of any preceding clause, further including causing a velocity of the portion of the core air in the recirculation zone to be less than a velocity of the core air that enters the turbo-engine.

The method of any preceding clause, the particle deflector assembly being positioned in an area of the engine plenum in which a mean path of the particles diverges from a mean path of the core air by at least 10°.

The method of any preceding clause, the particle deflector assembly being positioned in an area of the engine plenum in which the mean path of the particles diverges from the mean path of the core air in a range of 10° to 45°.

The method of any preceding clause, the mean path of the core air being angled with respect to the radially angled duct wall by ±20°.

The method of any preceding clause, further including deflecting the particles with the one or more particle deflector walls such that the particles spread circumferentially along the particle deflector assembly.

The method of any preceding clause, further including preventing at least 50% of the particles that enter the air intake from entering the turbo-engine with the particle deflector assembly.

The method of any preceding clause, further including directing the particles towards the recirculation zone when the particles impinge on the one or more particle deflector walls.

The method of any preceding clause, further including heating the particle deflector assembly such that the particles melt upon contact the particle deflector assembly.

The method of any preceding clause, further including retaining the particles within the one or more deflector chambers.

The method of any preceding clause, further including directing the particles into the one or more deflector chambers through the chamber opening defined between the first particle deflector wall and the second particle deflector wall.

The method of any preceding clause, further including directing the particles to impinge on the first particle deflector surface and directing the particles towards the second particle deflector wall with the first particle deflector wall.

The method of any preceding clause, further including directing the particles from the first particle deflector wall to the second particle deflector wall such that the particles impinge on the second particle deflector surface and directing the particles into the one or more deflector chambers with the second particle deflector wall.

The method of any preceding clause, the particle deflector assembly including one or more deflector chamber walls disposed within the one or more deflector chambers and extending axially within the one or more deflector chambers, and the method including preventing the particles from flowing out of the one or more deflector chambers with the one or more deflector chamber walls.

The method of any preceding clause, the one or more particle deflector walls including at least one particle deflector wall that is disposed at a core air deflector angle with respect to a mean path of the core air in the engine plenum, the core air deflector angle being in a range of 0° to 60°.

The method of any preceding clause, the particle deflector assembly being positioned at the intersection the mean path of the core air entering the engine plenum and the mean path of the air entering the radial inlet.

The method of any preceding clause, a mean path of the core air entering the engine plenum being at an angle in a range of 30° to 90° with respect to a mean path of the air entering the radial inlet.

Although the foregoing description is directed to the preferred embodiments of the present disclosure, other variations and modifications will be apparent to those skilled in the art and may be made without departing from the spirit or the scope of the disclosure. Moreover, features described in connection with one embodiment of the present disclosure may be used in conjunction with other embodiments, even if not explicitly stated above.

1. A turbine engine comprising:
an engine plenum disposed within the turbine engine and defined at least partially by a plenum end wall;
a turbo-engine disposed within the engine plenum, wherein the turbine engine causes core air to flow through the engine plenum and into the turbo-engine; and
a particle deflector assembly disposed at the plenum end wall, the particle deflector assembly comprising one or more particle deflector walls that extend into the engine plenum and capture particles within the core air.

2. The turbine engine of claim 1, wherein the one or more particle deflector walls of the particle deflector assembly define a recirculation zone such that the one or more particle deflector walls cause a portion of the core air to generate a swirl of the portion of the core air within the recirculation zone, and the recirculation zone decelerates the particles.

3. The turbine engine of claim 1, wherein the one or more particle deflector walls include one or more particle deflector surfaces, at least one of the one or more particle deflector surfaces is defined by a bottom surface of the one or more particle deflector walls, and the particles impinge on the one or more particle deflector surfaces.

4. The turbine engine of claim 1, wherein the particle deflector assembly defines a bleed flow opening defined by the one or more particle deflector walls, the bleed flow opening directing a portion of the core air entering the bleed flow opening to flow out of the particle deflector assembly and towards the turbo-engine.

5. The turbine engine of claim 1, wherein the particle deflector assembly is positioned radially inward and axially aft of an area of the engine plenum in which a mean path of the particles diverges from a mean path of the core air in a range of 10° to 45°.

6. The turbine engine of claim 1, wherein the one or more particle deflector walls include at least one particle deflector wall that is disposed at a particle deflector angle with respect to a mean path of the particles, the particle deflector angle being in a range of 30° to 90°.

7. The turbine engine of claim 1, wherein the turbo-engine defines a radial inlet for receiving the core air into the turbo-engine, and the particle deflector assembly is positioned upstream of the radial inlet.

8. The turbine engine of claim 7, wherein a mean path of the core air entering the engine plenum is at an angle in a range of 30° to 90° with respect to a mean path of the core air entering the radial inlet.

9. The turbine engine of claim 1, further comprising a propeller drivingly coupled to the turbo-engine, the propeller rotating to direct the core air into the engine plenum.

10. The turbine engine of claim 9, further comprising a longitudinal centerline axis and an air intake in fluid communication with the engine plenum and positioned radially outward from the longitudinal centerline axis, the air intake directing the core air from the propeller to the engine plenum.

11. The turbine engine of claim 10, further comprising an intake duct defined between the air intake and the engine plenum, the intake duct providing fluid communication between the air intake and the engine plenum and directing the core air from the air intake to the engine plenum.

12. A method of separating particles in a turbine engine, the method comprising:
directing core air into an engine plenum that is disposed within the turbine engine and defined at least partially by a plenum end wall such that the core air impinges on the plenum end wall and is directed into a turbo-engine disposed within the engine plenum; and
separating the particles within the core air with one or more particle deflector walls of a particle deflector assembly that is disposed at the plenum end wall and extends into the engine plenum such that the particle deflector assembly captures the particles.

13. The method of claim 12, further comprising generating a swirl of a portion of the core air with the one or more particle deflector walls of the particle deflector assembly to define a recirculation zone, and decelerating the particles in the recirculation zone.

14. The method of claim 12, wherein the one or more particle deflector walls include one or more particle deflector surfaces, at least one of the one or more particle deflector surfaces is defined by a bottom surface of the one or more particle deflector walls, and the method further comprises causing the particles to impinge on the one or more particle deflector surfaces.

15. The method of claim 12, wherein the particle deflector assembly further comprises a bleed flow opening defined by the one or more particle deflector walls, and the method further comprises directing, by the bleed flow opening, a portion of the core air out of the particle deflector assembly and towards the turbo-engine.

16. The method of claim 12, further comprising disposing at least one particle deflector wall of the one or more particle deflector walls at a core air deflector angle with respect to the plenum end wall such that the at least one particle deflector wall extends away from the plenum end wall, and the core air deflector angle is in a range of 0° to 60°, and capturing the particles with the at least one particle deflector wall that is disposed at the core air deflector angle.

17. The method of claim 12, further comprising positioning the particle deflector assembly radially inward and axially aft of an area of the engine plenum in which a mean path of the particles diverges from a mean path of the core air in a range of 10° to 45°, and separating the particles from the core air at the area of the engine plenum in which the mean path of the particles diverges from the mean path of the core air such that the particle deflector assembly captures the particles.

18. The method of claim 12, wherein the turbo-engine defines a radial inlet and the particle deflector assembly is positioned upstream of the radial inlet, and the method further comprises directing the core air through the radial inlet into the turbo-engine.

19. The method of claim 12, wherein the turbine engine comprises a propeller drivingly coupled to the turbo-engine, and the method further comprises causing the propeller to rotate to generate the core air and directing the core air into the engine plenum.

20. The method of claim 19, wherein the turbine engine comprises a longitudinal centerline axis and an air intake in fluid communication with the engine plenum and positioned radially outward from the longitudinal centerline axis, and the method further comprises directing the core air through the air intake from the propeller to the engine plenum.
